(19) United States
(12) Patent Application Publication
(10) Pub. No.: US 2022/0282347 A1
(43) Pub. Date: Sep. 8, 2022

(54) METHOD AND DEVICE FOR PRODUCING A PRESSING TOOL

(71) Applicant: HUECK Rheinische GmbH, Viersen (DE)

(72) Inventors: Berthold THOELEN, Viersen (DE); Joerg ALBRECHT, Viersen (DE); Thorsten HAGEDORN, Viersen (DE)

(73) Assignee: HUECK Rheinische GmbH, Viersen (DE)

(21) Appl. No.: 17/634,725

(22) PCT Filed: Aug. 12, 2020
(86) PCT No.: PCT/EP2020/072675

§ 371 Date: Feb. 14, 2022

(30) Foreign Application Priority Data
Aug. 14, 2019 (DE) 10 2019 121 861.6

(51) Int. Cl. C21D 1/09; B30B 15/06; C21D 9/46

(52) U.S. Cl. CPC C21D 1/09; B30B 15/065; C21D 9/46

(57) ABSTRACT

A method and a device produces a pressing tool. A pressing tool is provided for producing a workpiece, which pressing tool includes a structured pressing surface of metal with elevations and recesses. Subsequently, a laser or an electron beam device is controlled such that a laser beam generated by the laser and/or an electron beam generated by the electron beam device is directed onto the pressing surface and hits it, such that the pressing surface is laser hardened and/or electron beam hardened.

The invention relates to a method and a device for producing a pressing tool.

Pressing tools, for example in the form of pressing plates, endless belts or embossing rollers, have a structured pressing surface and are, for example, used in the woodworking industry, for example to produce furniture, laminates or panels, i.e. in general workpieces. The workpieces are pressed with the structured pressing surface of the pressing tool, such that the workpieces obtain structured surfaces corresponding to the structured pressing surface.

WO 2009/062488 A2 discloses a pressing plate with a structured pressing surface. The structured pressing surface comprises a structure that has a mountain-like surface with valleys and heights. By use of the pressing surface, a workpiece formed as a material board with a structured surface may be produced. The structured pressing surface comprises a full-surface chromium layer, which is in contact with the material board during pressing.

WO 03/016034 A1 discloses a further pressing plate with a structured pressing surface. In order to reduce the wear of the pressing plate, the structured pressing surface is provided with a coating consisting of carbon with diamond-like layers and having a surface hardness of more than 1800 HV according to Vickers.

It is the object of the invention to indicate a possibility by which the pressing surface of a pressing tool can be designed to be relatively wear-resistant in a relatively simple and environmentally-friendly manner.

The object of the invention is achieved by a method for producing a pressing tool, comprising the following method steps:
providing a pressing tool which is provided for producing a workpiece and which comprises a structured pressing surface of metal with elevations and recesses,
controlling a laser or an electron beam device such that a laser beam generated by the laser and/or an electron beam generated by the electron beam device is directed onto the pressing surface and hits it, such that the pressing surface is laser hardened and/or electron beam hardened.

The object is also achieved by a device for producing a pressing tool, wherein the pressing tool is provided for producing a workpiece and comprises a structured pressing surface of metal with elevations and recesses, and the device comprises a laser device with a laser and an electronic controller, which is configured to control the laser device such that a laser beam generated by the laser is directed onto the pressing surface and hits it, in order to laser harden the pressing surface. The device can comprise an electron beam device instead of the laser device. In this case, the electronic controller is configured to control the electron beam device such that an electron beam generated by the electron beam device is directed onto the pressing surface and hits it, in order to electron beam harden the pressing surface.

In particular, it is possible that precisely one laser is used or that multiple lasers are used. Hence, for example, the laser beam device can comprise precisely one laser or multiple lasers. If multiple lasers are used, the pressing surface may be processed by means of multiple laser beams which are generated by the lasers simultaneously.

The electron beam device may generate precisely one electron beam or multiple electron beams. If the electron beam device generates multiple electron beams, the pressing surface may be processed by means of the multiple electron beams simultaneously.

Accordingly, by the method according to the invention and/or the device according to the invention, a pressing tool for producing a workpiece comprising a structured pressing surface of metal with elevations and recesses, which is laser hardened and/or electron beam hardened, is provided. Typically, the elevations have a height of 10 μm to 900 μm am and in most cases of μm 5 μm am to 200 μm am.

The produced pressing tool is, for example, an endless belt, an embossing roller or, preferably, a pressing plate and comprises the structured pressing surface. The pressing tool is provided for the production of a workpiece which obtains a structured surface corresponding to the structure of the pressing surface due to the structured pressing surface. During the production of the workpiece, it is pressed with the pressing tool and/or with the pressing surface thereof, whereby the pressing surface wears off.

The workpiece is, for example, a material board. It, for example, comprises a carrier, for example an MDF board or a chipboard, which is pressed with a resin-impregnated paper or with a plastic web by means of the pressing tool. The material board may also be a so-called luxury vinyl tile (LVT).

The structured pressing surface of the pressing tool is made of metal and, preferably, is a chromium-free structured pressing surface of metal, in particular of nickel, steel or stainless steel and is laser hardened by means of the laser and/or its laser beam or electron beam hardened by means of the electron beam device and/or its electron beam. Hence, the pressing surface becomes harder and wears off less. Moreover, laser hardening and/or electron beam hardening of the pressing surface is a relatively environmentally friendly method of hardening the pressing surface, since environmentally harmful chemicals or, optionally, the use of a chromium layer, which is environmentally hazardous in its production, as a pressing surface can be dispensed with.

The pressing tool provided for the inventive method can be produced according to conventional methods, such as by etching, as is generally known e.g. from WO 2009/062488 A2, prior to laser hardening and/or electron beam hardening. However, the pressing surface in particular is not provided with the chromium layer, which is environmentally hazardous in its production, but is hardened by means of the laser and/or the electron beam device. The laser and/or electron beam device is controlled by the electronic controller such that the laser beam generated by the laser and/or the electron beam generated by the electron beam device hits the pressing surface to harden it.

It can be provided that the entire pressing surface is laser hardened using the laser and/or is electron beam hardened using the electron beam device.

According to an embodiment of the method according to the invention, it comprises controlling the laser such that the laser beam generated by the laser is directed onto the pressing surface such that the laser beam hits merely predetermined regions of the pressing surface such that merely predetermined regions of the pressing surface are laser hardened. Accordingly, it may be provided that the method according to the invention comprises controlling the electron beam device such that the electron beam generated by the electron beam device is directed onto the pressing surface such that the electron beam hits merely predetermined regions of the pressing surface such that merely predetermined regions of the pressing surface are electron beam hardened.

According to this variant, it is thus provided that the pressing surface is just partially hardened using the laser and/or the electron beam device.

Accordingly, according to a variant of the device according to the invention, its electronic controller is configured to control the laser device and/or the electron beam device such that the laser beam generated by the laser and/or the electron beam generated by the electron beam device is directed onto the pressing surface such that the laser beam and/or the electron beam hits merely predetermined regions of the pressing surface to laser harden and/or electron beam harden merely predetermined regions of the pressing surface.

Thus, preferably, the pressing tool is designed such that its pressing surface is laser hardened and/or electron beam hardened merely in predetermined regions.

Thereby, in particular, merely those regions of the pressing surface are hardened using the laser and/or the electron beam device which are subject to a relatively high load during production of the workpiece and thus are subject to an increased wear in comparison to the remaining pressing surface.

The pressing surface is structured and comprises the elevations and recesses.

According to a preferred embodiment of the method according to the invention and/or the device according to the invention, the predetermined regions are assigned to elevations of the pressing surface such that merely regions assigned to these elevations are laser hardened and/or electron beam hardened and/or such that the laser beam and/or the electron beam laser hardens and/or electron beam hardens merely regions assigned to these elevations. Thus, essentially, merely the elevations and/or at least a part of the elevations, which, in particular, are subject to a particular load during the production of the workpiece, are laser hardened and/or electron beam hardened, since, according to experience, the elevations are subject to a higher load than the recesses during the production of the workpiece. In particular, the regions of increased load can be determined empirically.

The elevations in particular have a height. Preferably, the elevations are laser and/or electron beam hardened up to a predetermined hardening depth. The hardening depth preferably amounts to at least 10% of the height of the highest elevation. This has proven to be advantageous regarding the costs for hardening and lifetime of the structured pressing surface.

According to a preferred embodiment of the method according to the invention and/or the device according to the invention, the laser and/or the electron beam device is controlled depending on image data and/or the electronic controller controls the laser device and/or the electron beam device depending on image data. The image data is e.g. design data or, preferably, is assigned to the structure of the structured pressing surface.

The structured pressing surface is, in particular, assigned to a natural material, such as wood or stone. In order to obtain the structure of the pressing surface, it can be provided that a model, for example a piece of wood or a stone is scanned to obtain image data. This image data in particular comprises information on the structure which the structured pressing surface should have.

The image data obtained by scanning can, for example, be edited manually to obtain image data assigned to the structure of the pressing plate. This image data can be used not only for controlling the laser and/or the laser device, but also for the production of the structure of the pressing surface, such as by etching.

If the pressing tool is, for example, the pressing plate, then in particular its structured pressing surface is designed to be rectangular and has a longitudinal extension and a transverse extension extending transversely to the longitudinal extension. The structure of the structured pressing surface can then have a preferential direction in the direction of the longitudinal extent or also in the direction of the transverse extent. For example, structured pressing surfaces which are assigned to wood and/or a wood grain have such a preferential direction.

The laser beam and/or the electron beam generally hits merely a relatively small section of the pressing surface and is, in particular, controlled such that the laser beam and/or the electron beam moves across the pressing surface. This can be achieved, for example, by moving the laser beam device and/or the electron beam device or by deflecting the laser beam and/or the electron beam using a mirror. This can be carried out such that the laser and/or electron beam is guided along the pressing surface in the form of columns or lines.

If the structure of the structured pressing surface has such a preferential direction, according to a preferred embodiment of the device according to the invention its electronic controller is configured to control or move the laser device such that the laser beam is guided alternately across the entire longitudinal extension and sectionally along the transverse extension of the pressing surface if the preferential direction extends along the longitudinal extension, or that the laser beam is guided alternately across the entire transverse extension and sectionally along the longitudinal extension if the preferential direction extends along the transverse extension.

If the electron beam device is used instead of the laser, then the electronic controller is preferably configured to control or move the electron beam device such that the electron beam is guided alternately across the entire longitudinal extension and sectionally along the transverse extension if the preferential direction extends along the longitudinal extension, or that the electron beam is guided alternately across the entire transverse extension and sectionally along the longitudinal extension if the preferential direction extends along the transverse extension.

Accordingly, the method according to the invention preferably comprises moving the laser or the electron beam device and/or deflecting the laser beam generated by the laser and/or the electron beam generated by the electron beam device such that the laser beam and/or the electron beam is guided alternately across the entire longitudinal extension and sectionally along the transverse extension, if the preferential direction extends along the longitudinal extension, or that the laser beam and/or the electron beam is guided alternately across the entire transverse extension and sectionally along the longitudinal extension if the preferential direction extends along the transverse extension.

The motion of the laser and/or of the electron beam device can, for example, be achieved in that the device comprises a support device, on which the pressing plate to be processed rests, and a motion device with which the laser and/or the electron beam device can be displaced in the direction of the transverse and longitudinal extensions controlled by the electronic controller.

Thus, according to a preferred embodiment device, the device for producing a pressing tool, in which the pressing tool is the pressing plate with the rectangular pressing surface, comprises a support device on which the pressing plate to be processed rests, and a motion device by means of which the laser and/or the electron beam device can be displaced in the direction of the transverse and longitudinal extensions controlled by the electronic controller. The electronic controller is, in particular, configured such that the motion device moves alternately across the entire longitudinal extension and sectionally along the transverse extension of the pressing surface if the preferential direction extends along the longitudinal extension, or the motion device moves alternately across the entire transverse extension and sectionally along the longitudinal extension if the preferential direction extends along the transverse extension.

Exemplary embodiments of the invention are shown in the enclosed schematic figures by way of example. These show:

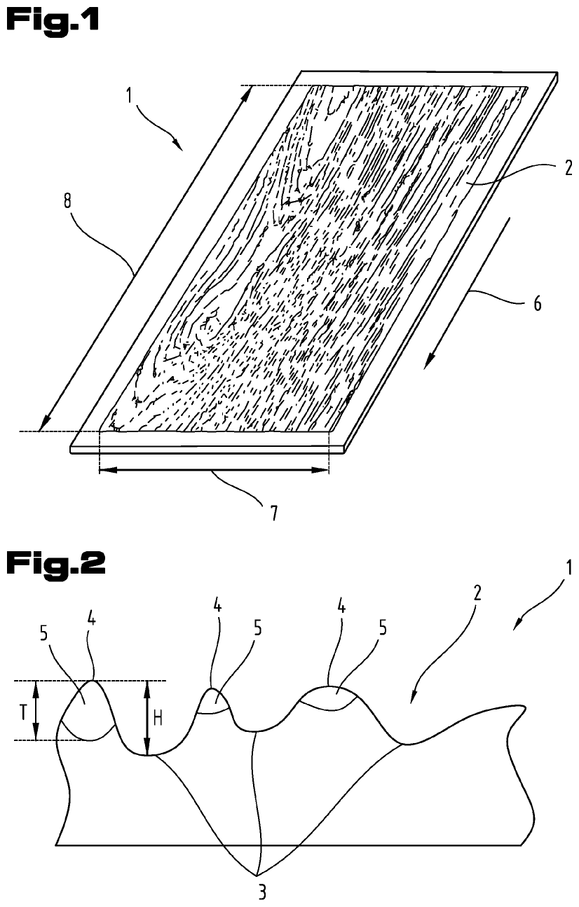

FIG. 1 a pressing plate with a pressing surface in a perspective representation,

FIG. 2 a cutout from a lateral view of the pressing plate in a sectional representation,

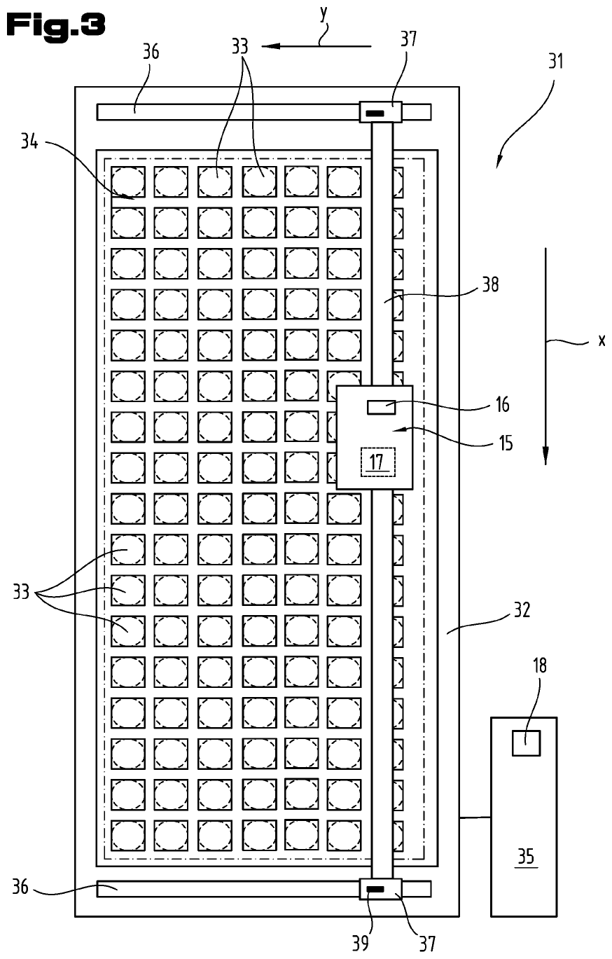

FIG. 3 a device for producing the pressing plate, and

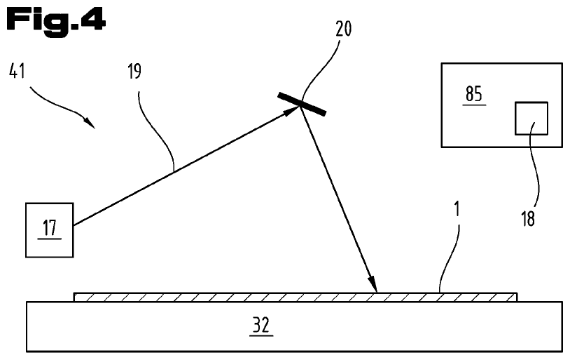

FIG. 4 an alternative device for producing the pressing plate.

FIG. 1 shows a perspective representation of a pressing plate 1 having a chromium-free, structured pressing surface 2 of metal as an example for a pressing tool, which comprises a chromium-free, structured pressing surface of metal. The pressing surface 2 is preferably made of steel.

The structured pressing surface 2 comprises a mountain-like surface with recesses 3 and elevations 4. The structured pressing surface 2 can, for example, be assigned to a wood grain. A cutout from a side view in sectional representation of the pressing plate 1 is shown in FIG. 2.

In case of the present exemplary embodiment the pressing surface is rectangular and has a transverse extension 7 and a longitudinal extension 8. Moreover, the structure of the structured pressing surface 2 extends along a preferential direction 6, which in the case of the present exemplary embodiment extends along the longitudinal extension 8.

By the pressing plate 1, a workpiece, e.g. a pressing plate, for example a laminate, can be produced by pressing. After pressing, the workpiece has a structured surface corresponding to the structured pressing surface 2.

In the case of the present exemplary embodiment, the pressing surface 2 comprises laser hardened predetermined regions 5, which are in particular assigned to the elevations 4, i.e. in the case of the present exemplary embodiment at least some of the elevations 4 are laser hardened and the remaining pressing surface 2, in particular its recesses 3, are not laser hardened.

FIG. 3 shows a device 31 for producing the pressing plate 1 and/or for laser hardening the pressing surface 2 in a top view.

In the case of the present exemplary embodiment, the device 31 shown in FIG. 3 comprises a support table 32 which has a support surface 34 made of multiple individual planar surfaces 33. For the production of the pressing plate 1 and/or for laser hardening the pressing surface 2 of the pressing plate 1, first, the pressing plate 1 with the unhardened pressing surface 2 is placed on the support surface 32 such that the pressing surface 2 faces away from the support surface 34.

The support surface 34 is, in particular, rectangular and has dimensions adapted to the dimensions of the pressing plate 1.

In the case of the present exemplary embodiment, the device 31 comprises an electronic controller 35 which controls the operation of the device 31.

In the case of the present exemplary embodiment, suction orifices, which draw the pressing plate 1 onto the planar surfaces 33 by means of a vacuum pump of the device 31, said vacuum pump not being shown and controlled by the electronic controller 35, are formed in the planar surfaces 33, whereby the pressing plate 1 is fixed on the support surface 34.

In the case of the present exemplary embodiment, the device 31 comprises guide rails 36 which are arranged in transverse direction of the support surface 34 and next to the support surface 34.

The device 31, in particular, comprises sliding guides 37 which are mounted so as to be displaceable along the guide rails 36.

The device 31 comprises a longitudinal rail 38 which is aligned in particular longitudinally to the support surface 34 and which is connected to the sliding guides 37 on each of its ends.

The device 31 further comprises a laser device 15 which is mounted so as to be displaceable along the longitudinal rails 38. The laser device 15 comprises at least one laser 17, i.e. precisely one laser 17 or multiple lasers 17, which can be controlled by the electronic controller 35.

It is also possible that the device 31 comprises multiple longitudinal rails 38 on each of which a laser device 15 which can be controlled by the electronic controller 35 is arranged, said laser device 15 being mounted so as to be longitudinally displaceable along the corresponding longitudinal rail 38.

In the case of the present exemplary embodiment, the device 31 comprises an electrical drive 39 which is configured to move the sliding guides 37 and thus the longitudinal rails 38 and/or the laser device 15 along the guide rails 36 and thus in transverse direction y of the support surface 34, controlled by the electronic controller 35.

In the case of the present exemplary embodiment, the device 31 comprises a further electrical drive 16 which is configured to move the laser device 15 along the longitudinal rails 38 and thus along the support surface 34, i.e. in the longitudinal direction x, controlled by the electronic controller 35.

In the case of the present exemplary embodiment, the pressing plate 1 rests on the support surface 34 such that it is directed along the longitudinal direction x with respect to its longitudinal extension 8 and along the transverse direction y with respect to its transverse extension 7.

The device 31 is designed such that the pressing plate 1 fixed on the support surface 34 is arranged between the support surface 34 and the laser device 15 and/or the at least one laser 17.

Thus, it is possible to move the at least one laser 17, controlled by the electronic controller 35, to the favored position relative to the pressing surface 2, such that a laser beam generated by the laser 17 or laser beams generated by the lasers is or are directed onto the pressing surface 1 and hits or hit it in the favored location.

In the case of the present exemplary embodiment, the device 31 is configured to harden the pressing surface 1 of the pressing plate 1 fixed on the support surface 34 using the at least one laser 17, in particular for hardening the predetermined regions 5, by the electronic controller 35 controlling the electrical drive 39, the further electrical drive 16 and the laser device 15 and/or its laser 17 such that the laser beam generated by the laser 17 and/or the laser beams generated by the lasers 17 hits predetermined regions 5 to harden these using the laser 17.

In the case of the present exemplary embodiment, image data 18 is stored in the electronic controller 35. The electronic controller 35 is, in particular, configured to control the electrical drive 39, the further electrical drive 16 and the laser device 15 and/or its at least one laser 17 depending on the image data. The image data 18 are assigned to the structure of the structured pressing surface 2.

The elevations 4, in particular, have a height H. Preferably, the elevations 4 are laser hardened up to a predetermined hardening depth T. The hardening depth T preferably amounts to at least 10% of the height H of the highest elevation 4. The highest elevation 4 can be determined based on the image data 18.

In the case of the present exemplary embodiment, the device 31 is designed such that its electronic controller 35 is configured to control the laser 17 and the electrical drives 16, 39 such that the laser 17 is guided alternately across the entire longitudinal extension 8 and sectionally along the transverse extension 7 of the pressing surface 2, i.e. primarily in the preferential direction 6 of the structuring of the structured pressing surface 2.

FIG. 4 shows a further device 41 for producing the pressing plate 1 and/or for laser hardening the pressing surface 2 of the pressing plate 1. This device 41 differs from the device 31 shown in FIG. 3 essentially in that the at least one laser 17 is not arranged so as to be displaceable relative to the support surface 34 of the support table 32 but that the laser device 15 comprises at least one displaceable and/or pivotable mirror 20, which, controlled by the electronic controller 35, moves the mirror 20 depending on the image data 18 such that the laser beam 19 generated by the laser 17 or the laser beams 19 generated by the lasers 17 is or are deflected such that it or they hits or hit the pressing surface 2 at the predetermined regions 5 to be hardened.

The device 31 shown in FIG. 3 may comprise an electron beam device instead of the laser device 15 which generates an electron beam instead of the laser beam 19. In this case, the electronic controller 35 controls the electron beam device instead of the laser device 15 such that instead of the laser beam 19, the at least one electron beam hits the unhardened pressing surface 2 to electron beam harden it, in particular to electron beam harden the predetermined regions 5 assigned to the elevations 4.

1: A method for producing a pressing tool (1), comprising the following method steps:
providing a pressing tool (1) which is provided for producing a workpiece and which comprises a structured pressing surface (2) of metal with elevations (4) and recesses (3),
controlling a mirror (20) and a laser (17) or an electron beam device such that a laser beam (19) generated by the laser (17) and/or an electron beam generated by the electron beam device is directed onto the pressing surface (2) via the mirror (20) and hits it, such that the pressing surface (2) is laser hardened and/or electron beam hardened.

2: The method according to claim 1, in which the structured pressing surface (2) of metal does not comprise any chromium layers.

3: The method according to claim 1, comprising controlling the laser (17) and the mirror (20) such that the laser beam (19) generated by the laser (17) is directed onto the pressing surface (2) such that the laser beam via the mirror (20) (19) hits merely predetermined regions (5) of the pressing surface (2), such that merely predetermined regions (5) of the pressing surface (2) are laser hardened, or comprising controlling the electron beam device and the mirror (20) such that the electron beam generated by the electron beam device is directed onto the pressing surface (2) such that the electron beam via the mirror (20) hits merely predetermined regions (5) of the pressing surface (2), such that merely predetermined regions (5) of the pressing surface (2) are electron beam hardened.

4: The method according to claim 3, in which the predetermined regions (5) are assigned to the elevations (4) of the pressing surface (2) such that merely regions assigned to the elevations (4) are laser hardened and/or electron beam hardened.

5: The method according to claim 3, wherein the elevations (4) have a height (H) and merely the elevations (4) or predetermined elevations (4) are laser hardened and/or electron beam hardened up to a predetermined hardening depth (T), wherein, in particular, the hardening depth (T) amounts to at least 10% of the height (H) of the highest elevation (4).

6: The method according to claim 1, comprising controlling the laser (17) and/or the electron beam device and the mirror (20) depending on image data (18) assigned to the structure of the structured pressing surface (2).

7: The method according to claim 1, in which the pressing tool is a pressing plate (1), the structured pressing surface (2) of which is rectangular and comprises a longitudinal extension (8) and a transverse extension (7) extending transversely to the longitudinal extension (8), and the structure of the structured pressing surface (2) has a preferential direction (6) in the direction of the longitudinal extension (8) or the transverse extension (7), comprising moving the mirror (20) and/or deflecting the laser beam (18) generated by the laser (17) and/or the electron beam generated by the electron beam device by means of the mirror (20) such that the laser beam (18) and/or the electron beam is guided alternately across the entire longitudinal extension (8) and sectionally along the transverse extension (7) if the preferential direction (6) extends along the longitudinal extension (8), or that the laser beam (18) and/or the electron beam is guided alternately across the entire transverse extension (7) and sectionally along the longitudinal extension (8) if the preferential direction (6) extends along the transverse extension (7).

8: A device for producing a pressing tool, wherein the pressing tool (1) is provided for producing a workpiece and comprises a structured pressing surface (2) of metal with elevations (4) and recesses (3), and
the device (31, 41) comprises a laser device (15) with a laser (17), a mirror (20) and an electronic controller (35), which is configured to control the laser device (15) and the mirror (20) such that a laser beam (19) generated by the laser (17) is directed onto the pressing surface (2) via the mirror (20) and hits it, in order to laser harden the pressing surface (2), or
the device (31, 41) comprises an electron beam device, a mirror (20) and an electronic controller (35), which is configured to control the electron beam device and the mirror (20) such that an electron beam generated by the electron beam device is directed onto the pressing surface (2) via the mirror (20) and hits it, in order to electron beam harden the pressing surface (2).

9: The device according to claim 8,
the electronic controller (35) of which is configured to control the laser device (15) and the mirror (20) such that the laser beam (19) generated by the laser (17) is directed onto the pressing surface (2) such that the laser beam (19) via the mirror (20) hits merely predetermined regions (5) of the pressing surface (2), in order to laser harden merely the predetermined regions (5) of the pressing surface (2), or
the electronic controller (35) of which is configured to control the electron beam device and the mirror (20) such that the electron beam generated by the electron beam device is directed onto the pressing surface (2) such that the electron beam via the mirror (20) hits merely predetermined regions (5) of the pressing surface (2), in order to electron beam harden merely the predetermined regions (5) of the pressing surface (2).

10: The device according to claim 9, in which the predetermined regions (5) are assigned to the elevations (4) of the pressing surface (2) such that the laser beam (2) and/or the electron beam laser hardens and/or electron beam hardens merely regions assigned to the elevations (4).

11: The device according to claim 9, wherein the elevations (4) have a height (H) and the device is configured to laser harden and/or electron beam harden merely the elevations (4) or predetermined elevations (4) up to a predetermined hardening depth (T), wherein, in particular, the hardening depth (T) amounts to at least 10% of the height (H) of the highest elevation (4).

12: The device according to claim 8, the electronic controller (35) of which controls the laser device (15) and/or the electron beam device and the mirror (20) depending on image data (18) assigned to the structure of the structured pressing surface (2).

13: The device according to claim 8, wherein the pressing tool is a pressing plate (1), the structured pressing surface (2) of which is rectangular and comprises a longitudinal extension (8) and a transverse extension (7) extending transversely to the longitudinal extension (8), and the structure of the structured pressing surface (2) has a preferential direction (6) in the direction of the longitudinal extension (8) or the transverse extension (7), additionally comprising a support device (32) on which the pressing plate (1) to be processed rests, wherein the laser (17) and/or the electron beam device can hit the pressing surface (2) in the direction of the transverse and longitudinal extensions (7, 8) via the mirror (20) controlled by the electronic controller (35), wherein the electronic controller (35) is configured to guide the laser (17) and/or the electron beam device via the mirror (20) alternately across the entire longitudinal extension (8) and sectionally along the transverse extension (7) of the structured pressing surface (2) if the preferential direction (6) extends along the longitudinal extension (8), or to guide the laser (17) and/or the electron beam device via the mirror (20) alternately across the entire transverse extension (7) and sectionally along the longitudinal extension (8) if the preferential direction (6) extends along the transverse extension (7).

14: A pressing tool for producing a workpiece, produced according to the method of claim 1, comprising a structured pressing surface (2) of metal with elevations (4) and recesses (3), which is laser hardened or electron beam hardened.

15: The pressing tool according to claim 14, the pressing surface (2) of which is laser hardened or electron beam hardened in predetermined regions (5), which are, in particular, assigned to the elevations (4) of the pressing surface (2), and/or the structured pressing surface (2) of metal does not comprise any chromium layers.
